(19) United States
(12) Patent Application Publication
(10) Pub. No.: US 2021/0268866 A1
(43) Pub. Date: Sep. 2, 2021

(54) SYSTEM FOR NOTIFICATIONS RELATED TO OBJECTS LOCATED IN VEHICLE COMPARTMENTS

(71) Applicant: DENSO International America, Inc., Southfield, MI (US)

(72) Inventors: Yu ZHANG, Farmington Hills, MI (US); Bilal ALASRY, Dearborn, MI (US); Doua VANG, Waterford, MI (US); Vikas UPMANUE, Novi, MI (US)

(21) Appl. No.: 16/802,784

(22) Filed: Feb. 27, 2020

(51) Int. Cl. B60H 1/00; H04W 4/021; G01G 19/12; G01K 3/10; G01K 3/00; G01S 19/14; B60K 35/00

(52) U.S. Cl. CPC B60H 1/00742; H04W 4/021; G01G 19/12; H04W 4/40; G01K 3/005; G01S 19/14; B60K 35/00; G01K 3/10

(57) ABSTRACT

A system in a vehicle includes a global positioning system (GPS) receiver configured to identify a location of the vehicle, a sensor configured to determine a temperature of one or more objects, and a processor in communication with the GPS receiver and the sensor. The processor is programmed to in response to a signal identifying the temperature below a threshold amount, output a notification to a display, wherein the notification identifies temperature sensitive objects in the vehicle compartment.

### TECHNICAL FIELD

The present disclosure relates to vehicles that include various vehicle compartments.

### BACKGROUND

Various vehicle compartments, such as a trunk, glove box, center console, may be utilized to store objects. For example, the trunk may be utilized to store groceries, gear and/or tools. Certain objects may be temperature sensitive and require certain temperatures for storage, such as frozen food. A driver and/or occupant of a vehicle may want to monitor temperature sensitive objects when they are stored so that they could be cared for properly.

### SUMMARY

According to one embodiment, a system includes a processor programmed to in response to a first signal identifying a vehicle compartment of a vehicle is closed, determine a first weight of objects in the vehicle compartment utilizing sensors in the vehicle, in response to a second signal identifying the vehicle compartment of the vehicle has had an open and close cycle, determine a second weight of objects in the vehicle compartment utilizing the sensors in the vehicle, determine that the objects are temperature sensitive utilizing the sensors in the vehicle and adjusting climate controls of the vehicle in response to the determination that the objects are temperature sensitive.

According to one embodiment, a system in a vehicle includes a global positioning system (GPS) receiver configured to identify a location of the vehicle, a sensor configured to determine the weight of one or more objects, a processor in communication with the GPS receiver and the sensor, the processor programmed to identify a point-of-interest (POI) associated with the location of the vehicle, in response to a signal identifying the vehicle compartment of the vehicle has had an open and close cycle and the POI, determine a second weight of objects in the vehicle compartment utilizing the sensors in the vehicle compartment, and adjust climate controls of the vehicle compartment in response to the determination that the objects are temperature sensitive.

According to one embodiment, a system in a vehicle includes a GPS receiver configured to identify a location of the vehicle, a sensor configured to determine a temperature of one or more objects; and a processor in communication with the GPS receiver and the sensor, the processor programmed to in response to a signal identifying the temperature below a threshold amount, output a notification to a display, wherein the notification identifies temperature sensitive objects in the vehicle compartment.

### BRIEF DESCRIPTION OF THE DRAWINGS

FIG. 1 illustrates an overview of a system 100 according to one embodiment.

FIG. 2 illustrates an exemplary flowchart 200 of a vehicle with a reminder related to unloading objects out of a vehicle.

FIG. 3 illustrates an exemplary flowchart 300 of a vehicle utilizing connected services or historic data associated with a location.

FIG. 4 illustrates an exemplary flowchart 400 of a utilizing sensor data to identify temperature sensitive objects.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Various vehicle compartments, such as a trunk, glove box, center console, may be utilized to store objects. For example, the trunk may be utilized to store groceries, gear and/or tools. Certain objects may be temperature sensitive and require certain temperatures for storage, such as frozen food. A driver and/or occupant of a vehicle may want to monitor temperature sensitive objects when they are stored so that they could be cared for properly. Temperature sensitive objects may include any type of object that has an optimal storage condition or that is sensitive to certain temperatures. For example, temperature sensitive objects may include frozen objects or hot objects, such as ice cream, soup, as well as, objects that need certain temperature requirements to preserve quality or safety, such as dairy products, medicine, etc. The temperature sensitive objects are not limited to edible objects and may include, for example, adhesives or caulks that may be utilized in home improvement. In addition, the vehicle system may determine that occupants may load and unload various objects in the vehicle compartment. In some cases, users of a vehicle (e.g., driver or occupant) may want to maintain supply of certain objects for a period of time. For example, maintain water supply for a road trip or preserve frozen groceries for a long trip. According to the principles of the present disclosure, the disclosure below would assist users to properly monitor whether they remember to load or unload the objects purchased at the point-of-interest (POI), whether certain objects should be stored or maintained in the vehicle compartments, identify a vehicle location to store the temperature sensitive objects, and/or identify how long those temperature sensitive objects could be stored in vehicle compartments, etc.

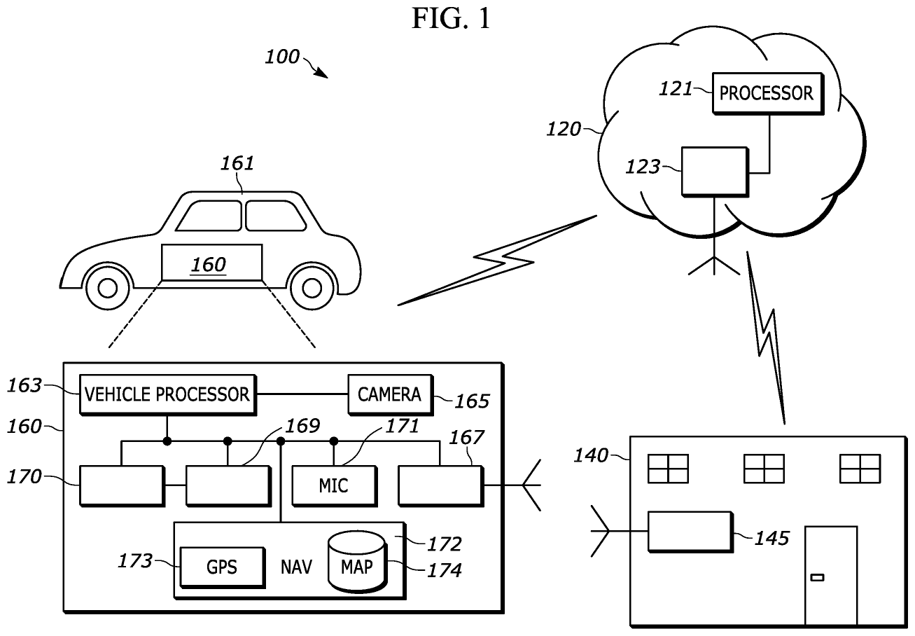

As shown in FIG. 1, a system 100 may include a remote server 120 (e.g., cloud), a store 140, and a vehicle 161 (e.g., customer vehicle). The vehicle 161 may include any type of vehicle, such as a passenger vehicle, a commercial vehicle, motorcycle, sport utility vehicle, minivan, sedan, watercraft, off-road vehicle, etc. The vehicle 161 may be equipped with a global positioning system (GPS) receiver 173. The GPS receiver 173 may receive signals transmitted from satellites for the GPS. The GPS receiver 173 may also be in communication with a gyroscope and/or a distance sensor. The vehicle GPS receiver 173 may also detect a position coordinate and altitude of the present position of the vehicle 161. If a gyroscope is utilized, the gyroscope may output a detection signal corresponding to an angular velocity of a rotational motion applied to the vehicle 161. The distance sensor may output a traveling distance of the vehicle 161. The present position may be calculated in various methods based on an output signal from the GPS receiver 173. For example, a single point positioning method or a relative positioning method may be used to calculate the present position of the vehicle 161.

The store 140 may be equipped with a transceiver 145. For example, such stores 140 may include POIs such as a grocery store, big-box retailer, shipping and packing store, post office, home improvement store, pharmacy, or any other location or retailer. The store 140 may utilize the transceiver 145 to communicate with the remote server 120, which may in turn share data with a mobile device associated with the customer or vehicle 161. The store 140 may collectively include all computer equipment that may be utilized to assist customers in shopping. For example, the store 140 may include a computer that includes a shopping list associated with a user, a check-out scanner, computer connected to an inventory database, etc.

The remote server 120 may include a data center controller 121. The data center controller 121 may include a microcomputer, which has a central processing unit (CPU), a read-only memory (ROM), a random access memory (RAM), an input/output (I/O) interface, and a bus line for coupling the CPU, the ROM, the RAM, and I/O interface. The remote server 120 may include a communication device 123 (e.g., wireless transceiver, telematics device, stand-alone mobile device, or mobile device paired with a Bluetooth transceiver. The data center controller 121 may communicate with the communication device 123 using any wired or wireless communication protocol, including but not limited to Long-Term Evolution (LTE), wireless fidelity (Wi-Fi), Bluetooth, WiGig, GPS, global navigation satellite system (GNSS), near field communication (NFC), or other telecommunication protocol. In an alternate embodiment, the vehicle 161 may also communicate wirelessly according to a known communication protocol such as, for example, Dedicated Short Range Communication (DSRC) protocol, Ultra-Wide Band (UWB) protocol, etc. The communication device 123 of the remote server 120 performs data communication with an associated mobile device of a driver of vehicle 161, the store 140, and the vehicle 161. The remote server 120 may be wirelessly coupled to a network via the communication device 123 to allow for data communication to various devices. The remote server 120 may include more than one data center or server.

The vehicle 161 may include a vehicle system 160 that includes a vehicle processor 163, camera 165, transceiver 167, microphone 171, and other systems or sub-systems (e.g., navigation system). The vehicle system 160 may also include a navigation apparatus. The navigation apparatus may be a portable terminal, such as a smart phone having a navigation function. The vehicle processor 163 may be utilized to send or collect data and other information from the camera 165, transceiver 167, GPS receiver 173, the microphone 171, and other vehicle components. For example, the vehicle processor 163 may be utilized to send instructions or commands to controllers associated with a vehicle compartment 169 to unlock or to provide access to the vehicle compartment 169. The transceiver 167 may be utilized to communicate with the mobile device of driver of the vehicle 161 via the remote server 120 (e.g., cloud) and associated telecommunications network. The transceiver 167 may be a telematics system or mobile device paired with the vehicle system 160. The transceiver 167 may be, for example, a Bluetooth transceiver or any wired or wireless transceiver. The microphone 171 may be allowed to receive spoken dialogue commands from a user in one embodiment. The microphone 171 may be configured to receive speech from the driver (e.g., the owner of the vehicle or someone who may utilize the vehicle), a delivery person or any other person. Additionally, a third party, such as a delivery person, may be able to communicate with a remote person utilizing the microphone 171. The microphone 171 may be located in an interior cabin of the vehicle 161 (such as a passenger cabin) or may be located in an exterior location of the vehicle 161.

The vehicle compartment 169 may include various sensors 170. The sensors 170 in the vehicle compartment 167 may be utilized to detect if objects are being placed or removed from the vehicle compartment 169. For example, the vehicle compartment 169 may include one or more sensors 170 that may be a thermo sensor, scanning sensor, camera, weight sensor, motion sensor etc. In one example, the weight sensor may be placed in a floor or bottom surface of the vehicle compartment 169 to determine a fluctuation in weight of objects in the vehicle compartment 169. Thus, if objects are removed from the vehicle compartment 169, which in turns results in the total weight computed being reduced, it may be determined that objects were removed. However, if the total weight computed has increased, it can be determined that objects have been added. The computations of the weight can also work in conjunction with a camera or a scanning sensor that may include recognition features to identify packages or objects that are added or removed to the vehicle compartment 169. Similarly, if a motion (such as opening and closing the compartment) is detected by motion sensor, it may be determined that there is a change in number of objects stored in the compartment. The motion sensor may also be utilized with a camera or a scanning sensor to further identify the objects. For example, the motion sensor can detect motion of objects entering the vehicle compartment and begin to capture images to identify the objects. The vehicle compartment 169 may also work with a hands-free tailgate lifter that can detect motion around the vehicle 161. The hands-free tailgate lifter can thus detect such motion that is intended to open one or more compartments.

In another embodiment, the vehicle compartment 169 may include a thermo sensor that detects temperatures of certain objects. For example, the thermo sensor may be utilized to identify a cold object, such as ice cream, ice, frozen groceries, or other cold objects that must maintain a certain cold temperature, for example below freezing point of water. The thermo sensor may also be utilized to identify hot objects, such as a boiling water, soup, pizza, and other hot objects that may be maintained at a certain warm temperature, for example above room temperature. The vehicle compartment 169 may include certain areas that are cooler than others, or certain sections that are warmer than others. In another embodiment, the vehicle compartment 169 may include a warming section or refrigerated section that can keep objects warmer than room temperature or colder than room temperature.

The vehicle system 160 may include a navigation system 172 that may be configured to generate geographic data for the vehicle 161, such as via communicating with one or more satellites orbiting Earth. The geographic data may indicate a current geographic location of the vehicle 161, such as by including current longitude and latitude coordinates of the vehicle 161. As some non-limiting examples, the navigation system 172 may include one or more of a GPS receiver, a Quazi-Zenith Satellite System (QZSS) receiver, a Russian Global Navigation Satellite System (GLONASS) receiver, a Galileo System (GSNN) receiver, an Indian Regional Navigation Satellite System (IRKS S) receiver, and an inertial navigation system (INS) receiver.

The navigation system 172 may communicate the geographic data to the vehicle processor 163, which may be configured to utilize the geographic data to determine the geographic location of the vehicle 161, and to correspondingly determine the geographic location of detected proximate objects. The vehicle 161 may also include a gyroscope or compass configured to indicate a current heading of the vehicle 161 which the vehicle processor 163 may combine with the geographic data to produce data indicating the current location and heading of the vehicle 161. Alternatively, the vehicle processor 163 may determine the heading of the vehicle 161 based on received geographic data indicating a changed position of the vehicle 161 over a short time span (e.g., one second), which suggests that the vehicle 161 is moving in a direction corresponding to the change in position.

The vehicle processor 163 may be configured to query map data 174 based on the geographic data to identify information about the travel infrastructure currently in use by the vehicle 161. In particular, the map data 174 may include detailed information about travel infrastructure in various geographic locations, such as road type (e.g., function class of the road, such as highway, city), road properties (e.g., one way, multi-lane, slope information, curvature information), detailed lane information (e.g., location, dimensions, restrictions such as no passing, turn-only, and traffic direction), and the locations and dimensions of curbs, sidewalks, traffic signals, traffic signs, and crosswalks relative to a road, as some non-limiting examples. Alternatively, the vehicle processor 163 may be configured to derive at least some of this information from proximity data generated by proximity sensors, such as via processing image data captured by camera 165 of the vehicle 161.

The vehicle system 160 may include at least one camera 165. In one embodiment, the camera 165 may be mounted in a rear-view mirror of the vehicle 161. In other embodiments, the camera 165 may be located anywhere in the vehicle cabin or outside of the vehicle 161, such as the sides of the vehicle cabin or on top of the vehicle cabin. The camera 165 may also be facing out of the vehicle cabin through a windshield of the vehicle 161 to collect imagery data of the environment in front of the vehicle 161. The camera 165 may be utilized to collect information and data regarding the front of the vehicle 161 and for monitoring the conditions ahead and/or around the vehicle 161. The camera 165 may also be used for monitoring the conditions ahead of the vehicle 161 and correctly detecting the positions of lane markers as viewed from the position of the camera 165 and the presence/absence, for example, of lighting of the head lights of oncoming vehicles. For example, the camera 165 may be utilized to generate image data related to the vehicle's surrounding, lane markings ahead, and other types of object detection (e.g., pedestrians, vehicles, cyclists, light posts, parking spots, etc.). The vehicle 161 may also be equipped with a rear camera (not shown) for similar circumstances, such as monitoring the vehicle's environment around the rear proximity of the vehicle 161. The camera 165 may be utilized to detect a delivery package being delivered to the vehicle 161 utilizing image recognition or scanning a quick response (QR) code. The camera 165 may also be utilized to detect objects related to the delivery. In another embodiment, the camera 165 may be utilized to identify people moving towards the vehicle compartment (e.g., the trunk) and to identify objects that are being moved towards or into the vehicle compartment 169.

The camera 165 may also be an in-vehicle camera that may be mounted in the vehicle 161 to monitor occupants (e.g., a driver or passenger) within the vehicle cabin. The in-vehicle camera may be utilized to capture images of the vehicle cabin. For example, the in-vehicle camera may be utilized to obtain facial information from the delivery driver or the delivery package (e.g., a box). The in-vehicle camera may be a color camera, infrared camera, or time-of-flight camera. The in-vehicle camera may be mounted on a head rest, in the headliner, or located on a mobile device (e.g., tablet or mobile phone).

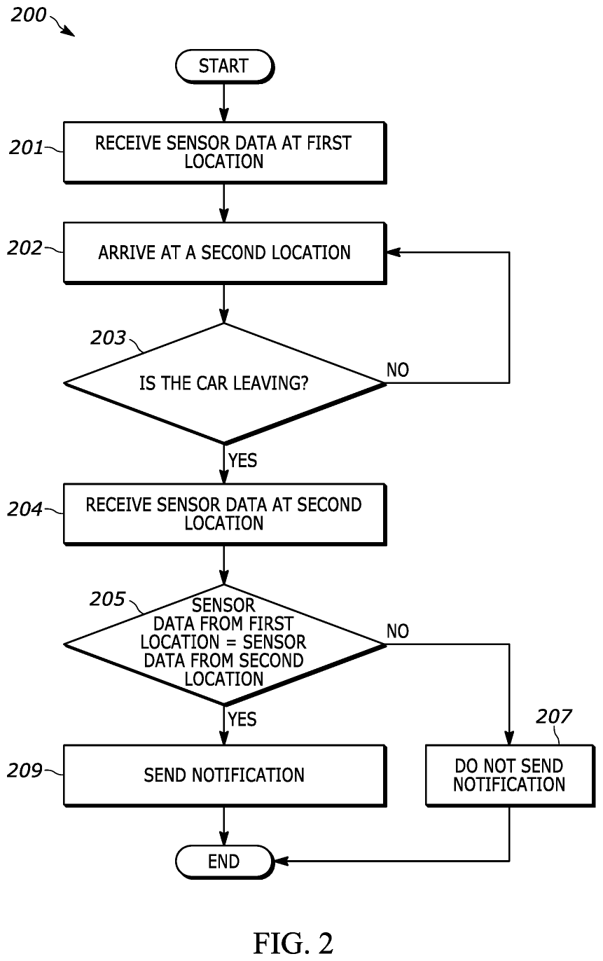

FIG. 2 illustrates an exemplary flowchart 200 of a vehicle (such as vehicle 161 described above in FIG. 1) with a reminder related to unloading objects out of the vehicle compartment (e.g., a trunk, glove box, center console). At step 201, the system may receive sensor data (e.g., also called vehicle compartment data) at a first location. The system may check various sensors to determine what changes have occurred in the vehicle compartment and various data related to objects being loaded or unloaded in the vehicle compartment. The system may utilize various sensors, such as weight sensors, thermo sensors, cameras, and other sensors to identify whether the trunk is loaded with the objects, weigh the objects, and/or count the objects. In one embodiment, the system (e.g., the sensors and associated processors) may take measurements of weight and/or object count at a first location. The first location may include any type of location, such as a place of work, home, grocery store, big-box retailer, shipping and packing store, post office, home improvement store, pharmacy, or any other location or retailer. The system may also monitor motion near the vehicle compartment (e.g., via a vehicle camera detecting someone) or activation of the vehicle compartment (e.g., hands-free tailgate, opening/closing of vehicle compartment, etc.) to trigger various vehicles sensors identifying a weight and/or item count at the vehicle compartment. Such monitoring may be utilized by cameras located at the vehicle. The system may utilize the sensor data to determine whether the objects may have been placed or removed from the vehicle compartment and take measurement of a weight and/or item count at that location. The sensor data may be stored in memory as pertaining to that specific location.

At step 202, the system may determine that the vehicle has arrived at a second location. The vehicle may utilize location information, such as GPS data, to identify that the vehicle is in a new location. The vehicle may continuously or periodically send such location information to the remote server to track the vehicle. In an alternative embodiment, the vehicle may send the location information when the vehicle is notified that the vehicle is at a location that enables the notification or reminder related to the vehicle compartment. For example, such locations may include a home or office of the driver of the vehicle. The locations may also include POIs such as a grocery store, big-box retailer, shipping and packing store, post office, home improvement store, pharmacy, or any other location or retailer. Thus, the vehicle and remote server may be in communication to notify one another of locations and associated POIs. The user may utilize GPS data to activate a notification for that specific location, or in other embodiments, disable any type of notifications for that specific location. The location information may be acquired from the navigation system utilizing GPS data and/or map data, or other sensors or data. When the vehicle is parked or an ignition off cycle occurs, the system may determine that the vehicle has arrived at the second location and may begin monitoring the vehicle compartment for loading or unload of various objects.

At decision 203, the vehicle or remote server may determine whether the vehicle is ready to depart or about to depart. The system may determine that the vehicle is ready to depart by utilizing driver open/door signal, ignition cycle counts, vehicle start counts (e.g., engine or motor start), vehicle on/off cycles, time cycle, navigation system data, vehicle speed, gear lever position, etc. For example, if the vehicle had an ignition off cycle at the second location and subsequently an ignition on cycle after a predetermined period (e.g., 30 seconds), the system may determine that the occupant may have picked up an object (e.g., a package) and is ready to depart. In another embodiment, the system may monitor navigation system data to determine if the vehicle has input a new destination in the navigation system and/or is ready to depart from the POI. If the vehicle is not leaving the second location, the vehicle may continuously send location information to the server to allow monitoring of the location of the vehicle. In another embodiment, the system may be in communication with the user's mobile device (e.g., phone, wearable device, tablet, etc.) to determine if the driver is approaching the vehicle, and thus leaving the location. For example, the driver's mobile phone may operate using Bluetooth low-energy connection from the vehicle to authorize access to the vehicle when a user is approaching the vehicle, sometimes called “Phone As A Key.”

At step 204, the system may receive sensor data at the second location to determine what changes have occurred in the vehicle compartment from the first location to the second location. Thus, various data related to objects being loaded or unloaded in the vehicle compartment may be collected and monitored at the second location. In one embodiment, the system may determine that the objects should be unloaded upon the vehicle being parked or being located at a specific type of POI, such as a home or work location, for example. In another embodiment, the system may determine whether or not each stop or location (e.g., the parked location) is a destination to unload the objects or not. The system may analyze the location information to determine if it is at a home location or a drop off point for the objects, then in turn, monitor the various sensor data collected at the vehicle compartment or other areas of the vehicle. For example, the system may utilize GPS information to identify that the vehicle is at home and then determine that the objects may need to be unloaded. In another embodiment, the system may check for motion data from not only the vehicle, but near the vehicle compartments. The system may monitor motion near the vehicle compartment (e.g., via a vehicle camera detecting someone) or activation of the vehicle compartment (e.g., hands-free tailgate, opening/closing of vehicle compartment, etc.). Such monitoring may be utilized by cameras located at the vehicle, for example. The system may utilize the various sensors to begin determining whether the objects may have been placed or removed from the vehicle compartment.

At step 205, the system may compare whether the sensor data (e.g., data associated with the objects of the vehicle compartment or motion near the vehicle compartment) collected at the first location is different than the sensor data collected at the second location. Thus, if the sensor data shows that the weight is the same between the two locations, the system may determine that the user has not unloaded the vehicle compartment. In the alternative, if the sensor data shows that the weight has changed between the two locations, the system may determine that the user has unloaded the items from the vehicle compartment. At step 207, if the system determines that the expected item count or weight is different from each location, the system may not output a notification to an occupant (e.g., driver or passenger) of the vehicle. However, at step 209, if the system determines that the expected item count or weight is the same or similar between the first and second location, the system may output a notification. Thus, the system may determine that the driver or occupants have unloaded all of the objects or the expected objects based on the various sensor data and historic data that may be utilized. For example, if the trunk has the same object count between the first and second location as identified by image data collected by a camera, the system may output a notification that may include a reminder to check the vehicle compartment. In another embodiment, the notification may include an exact number of objects that are identified in the vehicle compartment. In yet another embodiment, the notification may include details regarding the exact objects that are identified in the vehicle compartment.

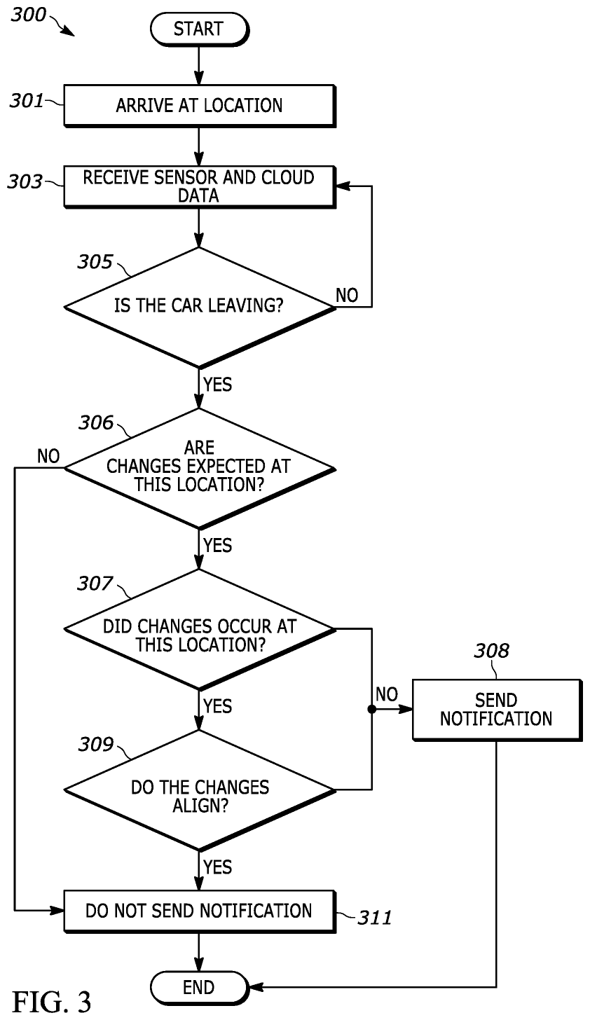

FIG. 3 illustrates an exemplary flowchart 300 of a vehicle (such as vehicle 161 described above in FIG. 1) utilizing connected services data or historic data associated with a location. At step 301, the vehicle may determine that the vehicle has arrived at a particular location via location information (e.g., GPS data). In an alternative embodiment, the location information may be sent from the vehicle to the remote server. The vehicle may continuously or periodically send location information to the remote server that is utilized for tracking the vehicle. In an alternative embodiment, the vehicle may send the location information when the vehicle is notified that it is at a location that enables the reminder. For example, such locations may include POIs such as a grocery store, big-box retailer, shipping and packing store, post office, home improvement store, pharmacy, or any other location or retailer. Thus, the vehicle and remote server may be in communication to notify one another of locations and associated POIs. The location information may be acquired from the navigation system utilizing GPS data and/or map data, or other sensors or data. In an alternative embodiment, the vehicle may send the information when the vehicle is at a location where the connected reminder is enabled. For example, such locations may include POIs like a grocery store, big-box retailer, shipping and packing store, post office, home improvement store, pharmacy, or any other location or retailer. The location information may be acquired from the navigation system utilizing GPS data and/or map data, or other sensors or data in the vehicle or associated mobile device. From there, the remote server may also retrieve information from the POI, such as a shopping list, order information, average time that a user or an average person spends in a POI, etc.

At step 303, the vehicle and remote server may communicate data related to the POI, and the vehicle may retrieve sensor data related to the vehicle compartment. The remote server may receive information from the POI, such as a shopping list, order information, items scanner information, etc. That data may be communicated to the vehicle to facilitate in providing the notification and reminders, as discussed in the steps later below. In one example, the vehicle may send navigation data and information indicating that the user is driving to a nearby Costco, and in turn, send data to the Costco regarding a shopping list that may be retrieved from the vehicle, mobile device associated with the user, or any other electronic device. The retail store, such as Costco, may then communicate data to be sent to the vehicle to identify notifications, if needed, about any of the objects that were purchased at the retailer. For example, the retail store may send data identifying item count, receipt information, weight information, form of payment, and other information to the vehicle to help identify a purchaser and information related to the items purchased at the retail store.

The system may also collect historic data by monitoring various changes that occur at the specific location or a category of the location (e.g., restaurant, grocery store, convenience store, etc.) over a predetermined period. In one example, the system may have monitored weight differences in the vehicle compartment at a specific POI or category of a POI. Other changes that may be monitored may include changes in objects that are loaded or unloaded at the location, actual objects that are placed in the vehicle compartment at the location, etc. The data associated with the location may be stored and derived over time from utilizing the various vehicle systems, such as the navigation system, cameras, and associated sensors with the vehicle compartments. For example, the navigation system may determine from the GPS receiver and POI database that the vehicle is parked at a Costco. Each time that the user is parked at the Costco, it may track the weight of objects loaded in the various vehicle compartments. For example, when the trunk is opened prior to a departure at a Costco, the system may determine that in most scenarios a cargo weight from two to ten pounds is stored in the trunk. In another scenario, the system may monitor unloading of compartments. For example, the navigation system may determine from the GPS receiver and navigation system that the vehicle is parked at home upon leaving a retailer (e.g., grocery store or Costco). Each time that the user is parked at home after leaving the retailer (e.g., Costco), it may track the weight of objects that were loaded in the various vehicle compartments and expect them to be unloaded. For example, when the trunk is opened upon arriving at home, the system may check the weight to determine if the same weight of cargo was unloaded. It may also utilize historic information from the sensor data to determine an average unloading weight for the arrival point (e.g., home). Thus, after every occurrence at a specific POI or category of POI, the system may monitor the objects loaded or unloaded.

At decision 305, the vehicle or remote server may determine whether the vehicle is ready to depart or about to depart. The system may determine that the vehicle is ready to depart by utilizing driver open/door signal, ignition cycle counts, vehicle start counts (e.g., engine or motor start), vehicle on/off cycles, time cycle, navigation system data, vehicle speed, gear lever position, etc. For example, if the vehicle had an ignition off cycle at the POI and subsequently an ignition on cycle after a predetermined period (e.g., 30 seconds), the system may determine that the occupant may have picked up an object (e.g., a package) and is ready to depart. In another embodiment, the system may monitor navigation system data to determine if the vehicle has input a new destination in the navigation system and/or is ready to depart from the POI. If the customer vehicle is not leaving the location, the vehicle may continuously send location information to the server to allow monitoring of the locations of the vehicle. In another embodiment, the system may be in communication with the user's mobile device (e.g., phone, wearable device, tablet, etc.) to determine if the driver is approaching the vehicle, and thus possible leaving the location. For example, the driver's mobile phone may operate using Bluetooth low-energy connection from the vehicle to authorize access to the vehicle when a user is approaching the vehicle.

At step 306, the system may determine whether any changes are expected to occur at this location. The changes may identify changes to weight, object count, and other data as related to the category of the location (e.g., restaurant or store), prior location (e.g., where did the driver stop at previously), or duration of the stay. For example, if the driver was previously at a store and then arrived home, the system may monitor and identify changes in the weight of objects in the trunk. However, if changes are expected at this location, the system may continue for further analyzation of what type of changes occurred to the data being monitored at the vehicle or vehicle compartment. The system may include a deviation and/or threshold for the amount of changes to occur at the location. For example, while a certain location may include a threshold loading or unloading of a particular weight (e.g., ten pounds) or number of objects (e.g., nine objects), it may allow for some deviation to mitigate variance in different trips. For example, the deviation may allow for +/−two pounds in weight or +/−two objects in the object count. In another embodiment, the vehicle may be in communication with an off-board server that has a shopping list or a grocery list for that location that the user is purchasing groceries from. Thus, the system may receive a data file including groceries or other objects to be purchased. The system may retrieve the data filing including the shopping list and utilize a camera or other sensor to identify whether those objects are found in the vehicle (e.g., the vehicle compartment). The image recognition may be able to identify the object and compare it to the list. In another embodiment, the objects purchased at the store may be sent via a remote server to the vehicle to be cross-referenced. For example, an item scanner at the retailer store may send a checklist of objects that are associated with the customer, that can be in turn be sent to the vehicle for cross-referencing with the vehicle compartment.

In another embodiment, the expected item count or change may be derived from data associated with the location (e.g., the POI) or from crowd sourced information. The data associated with the location may be stored and derived from other users over time from utilizing the various vehicle systems, such as the navigation system and associated sensors with the vehicle compartments. For example, the navigation system may determine from the GPS receiver and POI database that the vehicle is parked at a Costco. Each time that the user is parked at the Costco, it may track the weight of objects loaded in the various vehicle compartments. For example, when the trunk is opened prior to a departure at a Costco, the system may determine that most of the time a cargo weight from two to ten pounds is stored in the trunk. In another scenario, the system may monitor unloading of objects. For example, the navigation system may determine from the GPS receiver and navigation system that the vehicle is parked at home upon leaving a retailer (e.g., grocery store or Costco). Each time that the user is parked at home after leaving the retailer (e.g., Costco), it may track the weight of objects that were loaded in the various vehicle compartments and expect them to be unloaded. For example, when the trunk is opened upon arriving at home, the system may check the weight to determine if the same weight of cargo was unloaded. It may also utilize historic information from the sensor data to determine an average unloading weight for the arrival point (e.g., home).

Additionally or alternatively, the connected service option may also include trip planning that has a list of various other locations. The vehicle may automatically generate a checklist for trips based on prior behavior, crowd sourcing, or predefined use case. The system may then check whether the trunk has the complete checklist. The vehicle compartment may utilize the various sensors to cross-reference with the checklist that was received. For example, the vehicle may retrieve from the store or server, data that describes the checklist (e.g., grocery list), the total weight of the groceries, number of shopping bags, number of objects, electronic receipt, scanning the paper receipt, using a store supported connected service or using a user-programmed shopping list, etc. For example, a self-scanning system at a store may include weight sensors. The weight sensors may add the weight of every object that was purchased and send such data to the vehicle. The store may send the weight data to the vehicle.

At step 307, the system may determine if the expected changes did indeed occur at this location. The expected changes may be due to the category of the location (e.g., restaurant or store), prior location (e.g., where did the driver stop at previously), or duration of the stay. If the system monitors for the changes and they did not occur (e.g., item count or weight count has not changed), the system may send a notification to the user at step 308. The notification may include information that is output on a display within the vehicle (e.g., instrument cluster, navigation display, mobile device, etc.) that notifies a driver or other occupant of the location of the object and to check that location (e.g., the specific vehicle compartment). The estimation could be based on estimated weight, count of the object, and also consider whether there will be objects likely to be placed in the trunk, or just on top of a seat or near the foot-well of one of the seats. For example, a camera located in the trunk or other vehicle compartment may determine that the trunk is not a viable option to store objects. The system may then suggest another area. The notification may include an option to allow the driver to identify an appropriate location for the storage location, and thus allow for that location to be that storage location for similar objects in the future. For example, the notification may identify ice cream in the vehicle and include a setting that identifies preferred locations to store ice cream, or for the user to identify a location for such objects. For example, a certain location may be more optimal for the object to receive better coverage of in-vehicle heating, ventilation, and air conditioning (HVAC), such as areas by the air outlet. The system may suggest to store temperature sensitive objects in those areas if the HVAC creates desired heating or cooling (e.g., store ice-cream closer to HVAC in summer when HVAC provides cooling), or advise to store temperature sensitive objects away from those areas if the HVAC output is not desired (e.g., store ice-cream away from HVAC in winter when HVAC producing heat).

At step 309, the system may determine if the changes align with the expected changes based on historic data. The estimation may be based on the estimated weight, count of the item, and whether there will be objects to be placed in certain vehicle compartments versus others (e.g., compare weight at the trunk versus the weight on the seats or the foot-well of one of the seats). The system may have a threshold amount of change (e.g., in item count or weight count) that needs to occur at various locations of the vehicle or within various compartments. Upon placing the objects in the vehicle, the system may utilize one or more weight sensors located in one or more compartment locations to identify whether the weight of the objects is the same or similar as the weight data received. For example, the system may compare whether a same weight has been loaded to the vehicle by using the weight sensor, a same number of objects has been loaded by using cameras (e.g., image recognition), or whether all objects on the list or all bags are loaded to the vehicle by using either camera or scanning sensors. In another example, for a large grocery trip, the system may expect a weight change of greater than ten pounds in the trunk based on data provided by the store. If the system determines that the weight change of the vehicle is less than ten pounds (e.g., only two pounds of grocery added), it may output a notification 308. Thus, a notification 308 may be output if the changes at the vehicle are not aligned with what the system expects since the system may determine that the user has not loaded and/or unloaded all of the objects. Thus, because the weight change is below the expected change (based on the historic data), the notification may be output because the system may presume that the occupant did not purchase and/or load all items. In another example, the notification may inform the driver as to appropriate storage location of the objects, as well. For example, for objects that are temperature sensitive, the notification may include a location for such objects that is cooler than the rest of the vehicle. On the other hand, if the system determines that the weight change of the vehicle is greater than the expected change, which is ten pounds or more added to the vehicle compartment (e.g., twelve pounds of grocery added), the system does not provide a notification as shown at step 311. Thus, at step 311, the system may not send the notification when the changes align with the system's expectation. In other words, when the aligned changes occur, the objects have been loaded, unloaded, or properly stored.

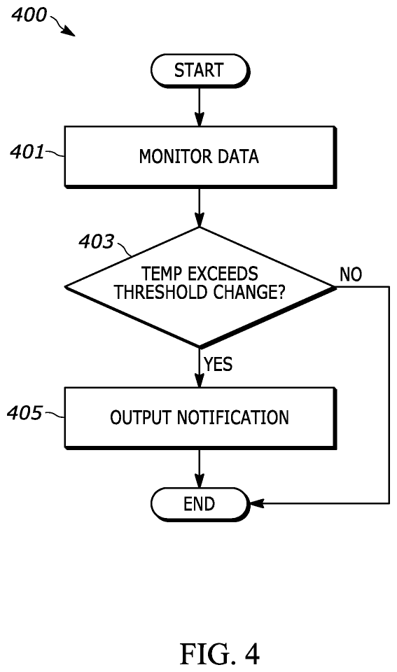

FIG. 4 illustrates an exemplary flowchart 400 of a vehicle (such as vehicle 161 described above in FIG. 1) utilizing sensor data to identify temperature sensitive objects. At step 401, the vehicle may monitor a vehicle compartment associated with the vehicle. The vehicle may continuously monitor sensor data from various sensors to determine if the vehicle compartment was opened or closed, to determine if objects may have been added. Additionally, the sensor data can identify and count objects utilizing a camera or other sensors. For example, cameras may utilize image recognition software to identify specific objects (e.g., boxes or defined shapes such as a rectangle or square) and count the number of objects. Additionally, the thermo sensor may identify temperature of each object to determine whether the object is temperature sensitive.

At step 403, the system may determine whether the temperature of an object exceeds a threshold change for that object. Thus, at a predetermined threshold change of temperature of an object, the object may be determined to be sensitive to temperatures and need to be frozen to be preserved in one embodiment, or kept warm in another embodiment. For example, the threshold may be 40 degrees Fahrenheit (° F.), 35° F., 30° F., etc. When the temperature of the object is greater than the predetermined threshold, the system may determine that the object is not temperature-sensitive. However, if the system determines that the temperature of the object is within the predetermined threshold, than the system may determine that the object is resilient to changes in temperature. In another embodiment, the system may include another predetermined threshold for objects that should be maintained at warm or warmer temperatures, such as a fresh, carry-out pizza or other object. In such an embodiment, the threshold may be 75° F., 80° F., 85° F., etc.

In another embodiment, the system may monitor rate of the temperature change for the object to provide a notification. For example, if the current temperature of an object is 0° F. and the temperature increases 6° F. every 10 minutes (or any threshold amount of time), the system may provide a notification to arrive at a destination within a certain time (e.g., under one hour) to prevent melting of the object (i.e., reaching 32° F.). The thermo sensor may be utilized to continuously monitor the temperature of the various objects over time, which may identify a rate of change of the temperature for certain objects. For example, the rate of change for ice cream may be different than a bag of ice. In yet another embodiment, data retrieved from the remote server may indicate a preservation rate or a preservation time related to the objects loaded into the vehicle. For example, if the user purchased pizza at a POI, the POI may send data to the vehicle via the remote server indicating a preservation time of one hour, for example. In yet another example, if the user purchased ice cream at a POI, the POI may send data to the vehicle via the remote server indicating a preservation rate that identifies the rate of change of temperature for the ice cream.

At step 405, the system may output a notification if the temperature of the object is greater than a predetermined threshold change of that object. The predetermined threshold change is a rate of change in temperature for the object. For example, a bucket of ice cream is best stored at is 0° F. The system may monitor for a change of +20° F. before providing a notification. In another embodiment, the predetermined threshold change may be related to a threshold temperature that may be exceeded. The notification may suggest a storage location for the objects to best preserve the temperature. For example, if the object is a frozen grocery item such as ice cream, the system may suggest an area in the vehicle that is cooler than other areas or to store in a designated fridge of the vehicle. The notification may also include an option to automatically activate a climate control to adjust the vehicle cabin temperature warmer or colder. For example, a notification may include an option to activate climate control settings. The activation may then send a signal to a climate control system of the vehicle to activate the climate control settings. The settings may activate a centralized adjustment to the climate system for a specific climate zone of the vehicle, or adjustment of the entire vehicle cabin, for example.

In another embodiment, the notification may suggest a departure time or arrival time so that the temperature sensitive object may be properly stored within an appropriate time. For example, the thermo sensor may be utilized to identify a frozen object and continuously monitor the temperature of the object. If the system detects a change in the temperature, it may send a notification notifying of the change in temperature and additionally notify the user to store the object. The system may also suggest a departure time. For example, a user may already have a frozen object in their vehicle. The user may be stopped at a different location, and the system may determine that the frozen object needs to be stored within a predetermined threshold period (e.g., 45 minutes). The system may also determine that the user needs a predetermined travel time (e.g., 15 minutes) to arrive to a safe place (e.g., a location to store the temperature sensitive object) from the current location. In this scenario, the system may output a notification to depart from the vehicle in less than 30 minutes to ensure preservation of the object. Thus, the system may calculate the time for the object to be stored in optimal conditions based on the temperature of the object. For example, if the user is driving to a destination that is far away (e.g., a large travel time) and needs to purchase a frozen object (e.g., ice cream), the system may suggest purchasing the object from a store that is closer to the destination. Thus, the system may calculate the distance or estimated time to the destination and a preservation time of the object that needs to be purchased. The system may also retrieve data indicating the objects to be purchased based upon a shopping list. The system may also retrieve data that indicates an estimate of the preservation time for those objects. For example, ice cream may have a preservation time of one hour, while milk may have a preservation time of two hours. In another example, the system may determine that the user needs ice cream (e.g., based on a shopping list or other similar data) and is driving to a destination four hours away. If the system determines that the ice cream would melt prior to arrival (e.g., melt within two hours from purchasing), it may suggest purchasing the ice cream at a location closer towards the destination and within a preservation period of that object.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system, comprising:
a processor programmed to:
in response to a first signal identifying a vehicle compartment of a vehicle is closed, determine a first weight of objects in the vehicle compartment utilizing sensors in the vehicle;
in response to a second signal identifying the vehicle compartment of the vehicle has had an open and close cycle, determine a second weight of objects in the vehicle compartment utilizing the sensors in the vehicle;
determine that the objects are temperature sensitive utilizing the sensors in the vehicle; and
adjusting climate controls of the vehicle in response to the determination that the objects are temperature sensitive.

2. The system of claim 1, wherein the processor is further programmed to output to a display a notification identifying temperature sensitive objects in the vehicle compartment.

3. The system of claim 1, wherein processor is further programmed to output the notification in response to a change in temperature of the object.

4. The system of claim 1, wherein the processor is further programmed to output a second notification in response to a rate of temperature change exceeding a threshold.

5. The system of claim 4, wherein the second notification includes a time warning.

6. The system of claim 1, wherein adjusting climate controls includes adjustment of a vehicle compartment temperature and fan setting.

7. The system of claim 1 The system of claim 1, wherein adjusting climate controls includes adjustment of a vehicle cabin temperature and fan setting.

8. The system of claim 1, wherein adjusting climate controls includes adjustment of a climate zone temperature and fan setting.

9. A system in a vehicle, comprising:
a global positioning system (GPS) receiver configured to identify a location of the vehicle;
a sensor configured to determine the weight of one or more objects; and
a processor in communication with the GPS receiver and the sensor, the processor programmed to:
identify a point-of-interest (POI) associated with the location of the vehicle;
in response to a signal identifying the vehicle compartment of the vehicle has had an open and close cycle and the POI, determine a second weight of objects in the vehicle compartment utilizing the sensors in the vehicle compartment; and
adjust climate controls of the vehicle compartment in response to the determination that the objects are temperature sensitive.

10. The system of claim 8, wherein the processor is further programmed to output on a display a reminder notifying a user about objects in the vehicle compartment.

11. The system of claim 8, wherein the processor is further programmed to adjust climate controls of the vehicle compartment in response to a time of day.

12. The system of claim 8, wherein the processor is further programmed to adjust climate controls of the vehicle compartment in response to weather of the day.

13. The system of claim 8, wherein the processor is further programmed to output a prompt to a user of the vehicle, wherein the prompt includes an option to adjust climate at the vehicle compartment.

14. The system of claim 13, wherein the processor is further programmed to receive an input associated with the prompt for adjustment at the vehicle compartment.

15. A system in a vehicle, comprising:
a global positioning system (GPS) receiver configured to identify a location of the vehicle;
a sensor configured to determine a temperature of one or more objects; and
a processor in communication with the GPS receiver and the sensor, the processor programmed to:
in response to a signal identifying the temperature below a threshold amount, output a notification to a display, wherein the notification identifies temperature sensitive objects in the vehicle compartment.

16. The system of claim 15, wherein the processor is further programmed to adjust a climate control setting of the vehicle in response to the temperature below the threshold.

17. The system of claim 15, wherein the processor is further programmed to identify a point-of-interest (POI) associated with the location of the vehicle and receive historic sensor data associated with the POI.

18. The system of claim 17, wherein the processor is further programmed to, in response to the historic sensor data, output a notification identifying objects to be stored in the vehicle or vehicle compartment.

19. The system of claim 17, wherein the processor is further programmed to receive the historic sensor data from a remote server via a transceiver in communication with the processor.

20. The system of claim 17, wherein the processor is further programmed to, in response to comparing a weight of the one or more objects from the sensor to a target weight received from the POI, output a notification related to the one or more objects in the vehicle compartment.
